(19) United States
(12) Patent Application Publication
(10) Pub. No.: US 2025/0181682 A1
(43) Pub. Date: Jun. 5, 2025

(54) DETERMINATION METHOD, COMPUTER, AND PROGRAM

(71) Applicant: Wacom Co., Ltd., Saitama (JP)

(72) Inventor: Ryoji ISHII, Saitama (JP)

(21) Appl. No.: 19/043,229

(22) Filed: Jan. 31, 2025

Related U.S. Application Data
(63) Continuation of application No. PCT/JP2023/028360, filed on Aug. 3, 2023.

(30) Foreign Application Priority Data
Aug. 3, 2022 (JP) 2022-123902

(51) Int. Cl. G06F 21/16; G06F 21/64; G06Q 30/018

(52) U.S. Cl. CPC G06F 21/16; G06F 21/64; G06Q 30/018

(57) ABSTRACT

To enable to certify authorship of an artwork with a simple method. Provided is a determination method of using a computer to determine authorship of an artwork, the determination method including specifying, by the computer, hardware or software used by an artist in creating the artwork, and generating, by the computer, a first certificate including identification information representing the specified hardware or software and a first DID that is a DID related to the artwork.

### BACKGROUND

### Technical Field

The present disclosure relates to a determination method, a computer, and a program.

### Description of the Related Art

In the past, a certificate of authenticity is generally used as a method of certifying the authorship of a work of art. A specific method for using a certificate of authenticity to certify that a craft artwork or the like is an authentic product is disclosed in Patent Document 1.

### PRIOR ART DOCUMENT

### Patent Document

Patent Document 1: Japanese Patent No. 6894033

### BRIEF SUMMARY

### Technical Problem

Incidentally, when a work of art to be certified is a work (hereinafter, referred to as “artwork”) digitally created by pen input or the like, the artwork can be copied any number of times. Therefore, the authorship cannot be sufficiently certified by the conventional certificate of authenticity.

Therefore, an object of the present disclosure is to provide a determination method, a computer, and a program that can certify the authorship of an artwork with a simple method.

### Technical Solution

The present disclosure provides a determination method of using a computer to determine authorship of an artwork, the determination method including specifying, by the computer, hardware or software used by an artist in creating the artwork, and generating, by the computer, a first certificate including identification information representing the specified hardware or software and a first DID (decentralized identifier) that is a DID related to the artwork.

The present disclosure provides a computer configured to specify hardware or software used by an artist in creating an artwork, and generate a first certificate including identification information representing the specified hardware or software and a first DID that is a DID related to the artwork.

The present disclosure provides a program for causing a computer to execute a process of specifying hardware or software used by an artist in creating an artwork, and generating a first certificate including identification information representing the specified hardware or software and a first DID that is a DID related to the artwork.

### Advantageous Effect

According to the present disclosure, the authorship of an artwork can be certified by a simple method of using hardware or software used by an artist in creating the artwork.

BRIEF DESCRIPTION OF THE SEVERAL VIEWS OF THE DRAWINGS

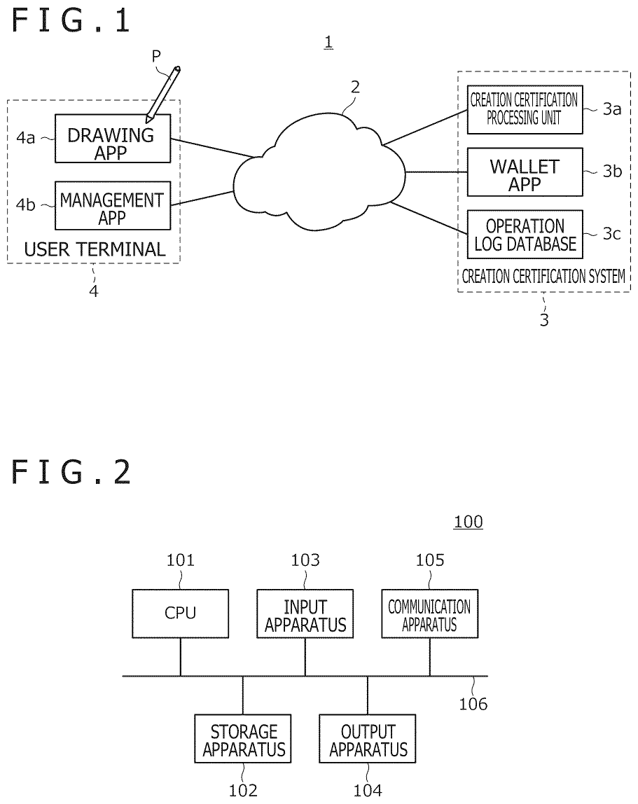

FIG. 1 is a diagram illustrating a configuration of an authorship certification system 1 according to the present embodiment.

FIG. 2 is a diagram illustrating an example of a hardware configuration of a creation certification system 3 and a user terminal 4.

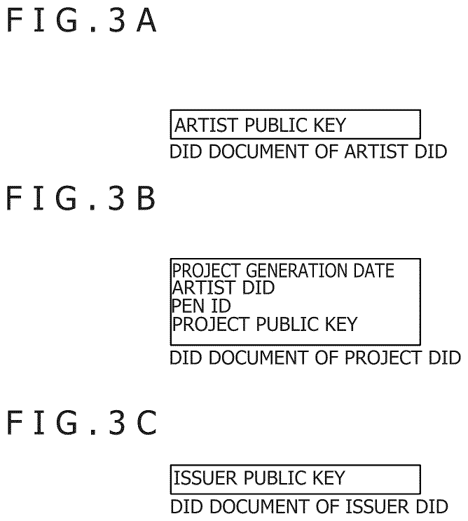

FIGS. 3A, 3B, and 3C are diagrams illustrating DID documents corresponding to three types of DIDs used in a process of the creation certification processing unit 3a.

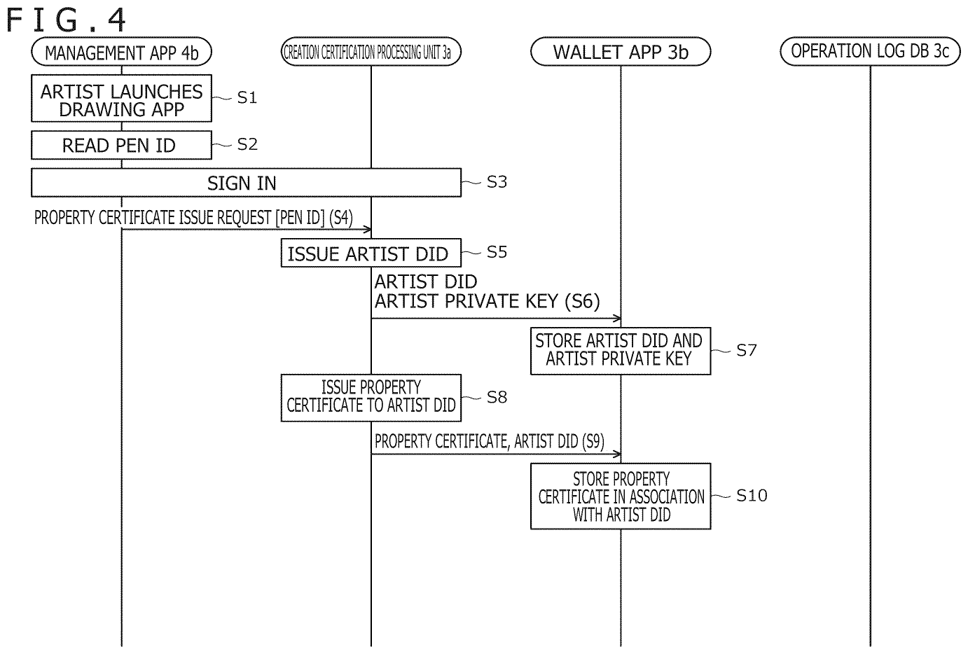

FIG. 4 is a process flow chart illustrating a process regarding issuance of a property certificate.

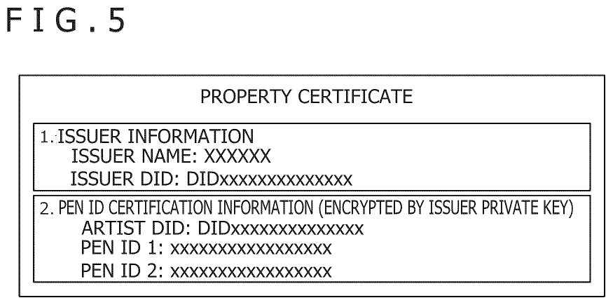

FIG. 5 is a diagram illustrating content of the property certificate issued in step S8 of FIG. 4.

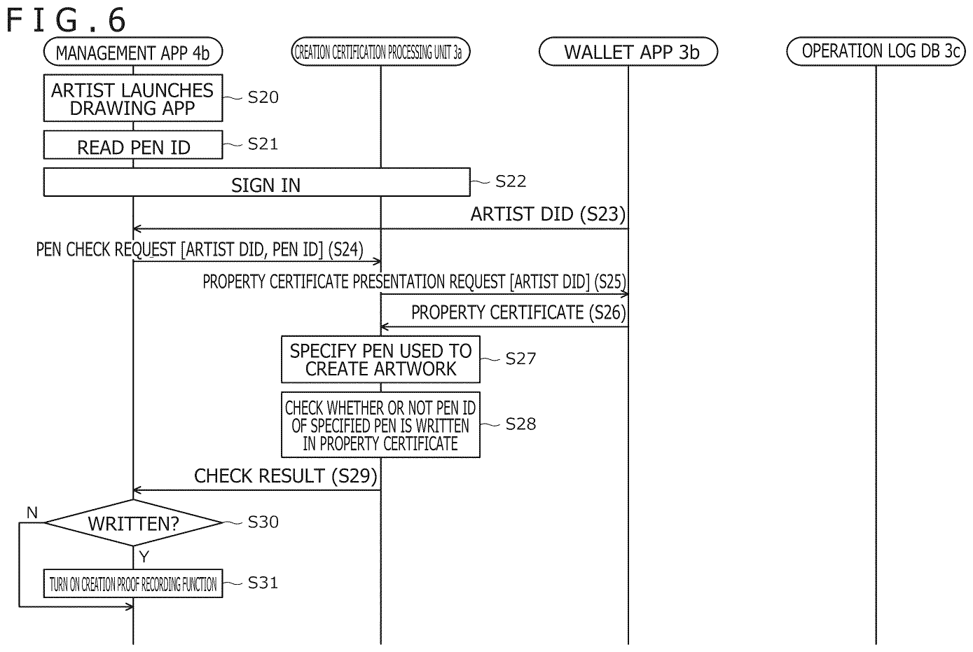

FIG. 6 is a process flow chart illustrating a process regarding issuance of an artwork certificate.

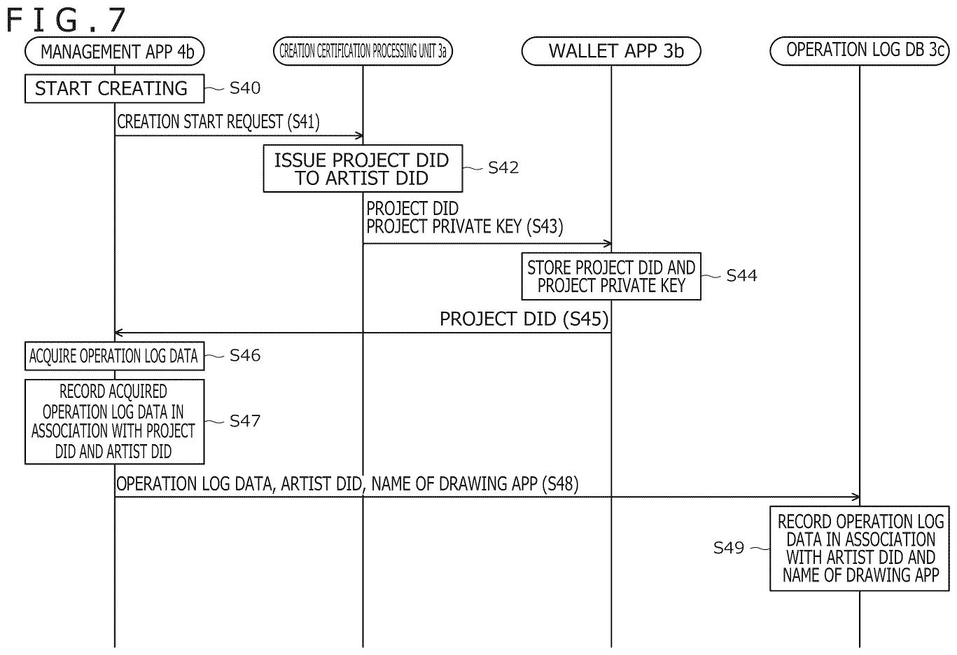

FIG. 7 is a process flow chart illustrating the process regarding the issuance of the artwork certificate.

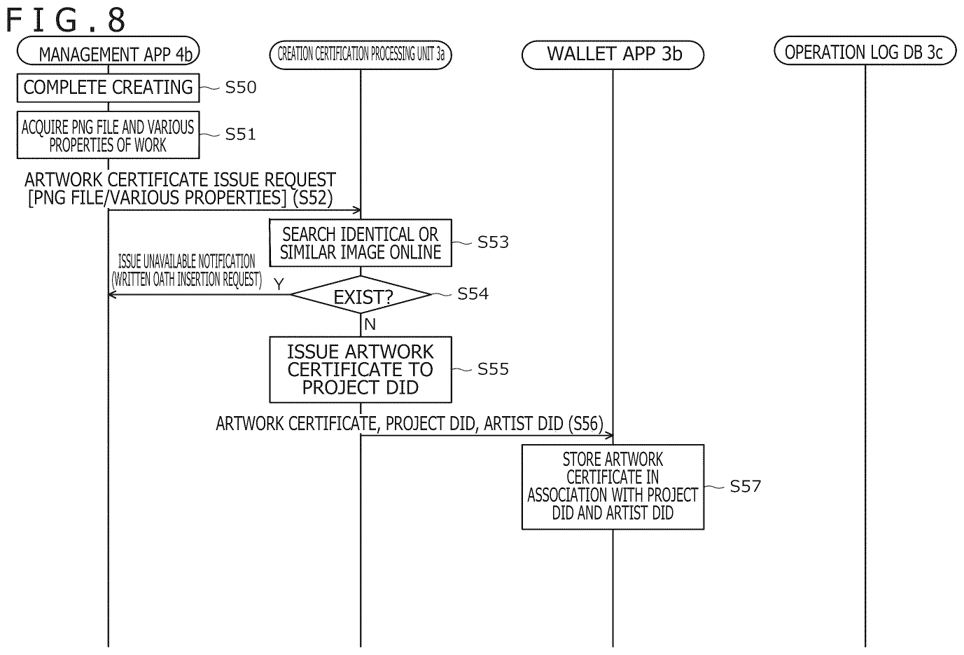

FIG. 8 is a process flow chart illustrating the process regarding the issuance of the artwork certificate.

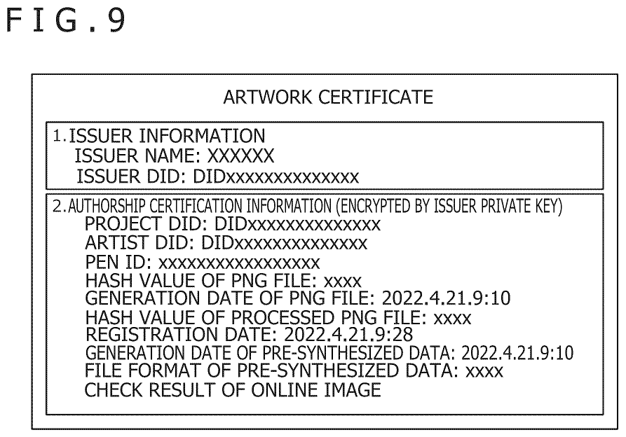

FIG. 9 is a diagram illustrating content of the artwork certificate issued in step S55 of FIG. 8.

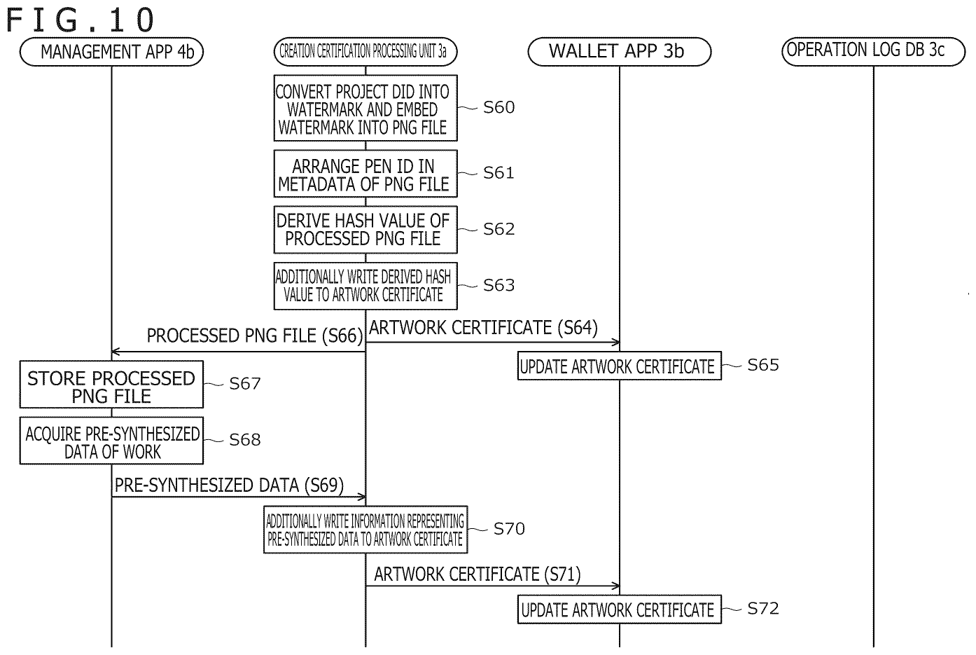

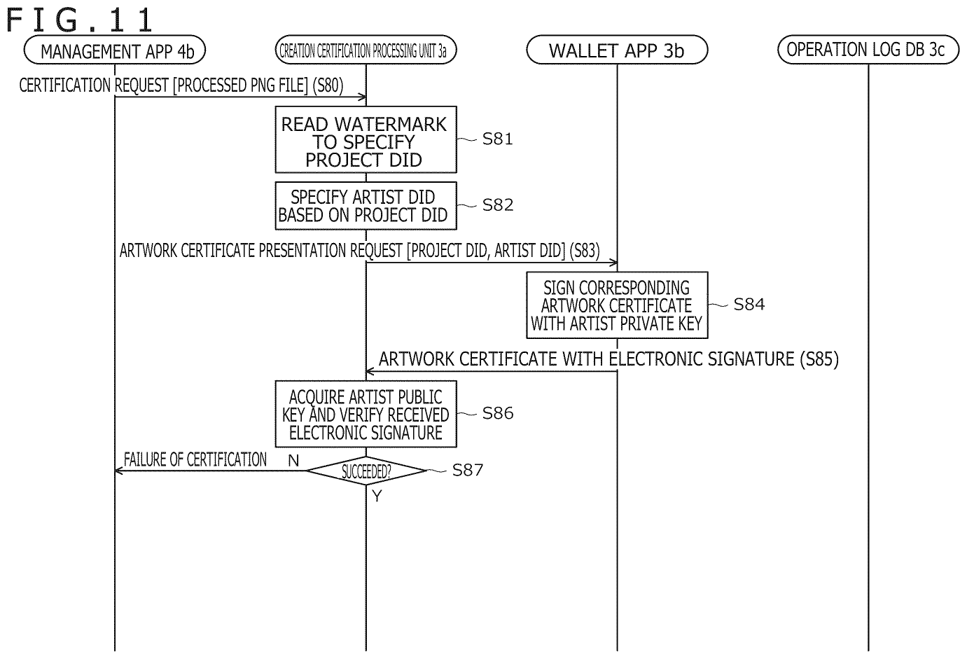

FIG. 10 is a process flow chart illustrating the process regarding the issuance of the artwork certificate.

FIG. 11 is a process flow chart illustrating a process regarding certification of authorship performed by using the property certificate and the artwork certificate.

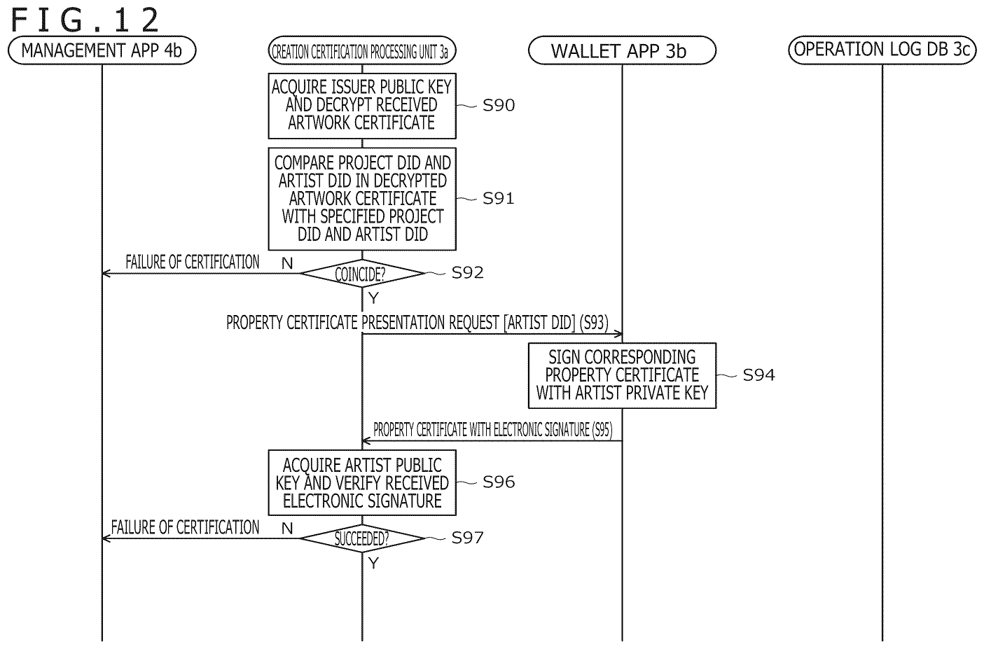

FIG. 12 is a process flow chart illustrating the process regarding the certification of the authorship performed by using the property certificate and the artwork certificate.

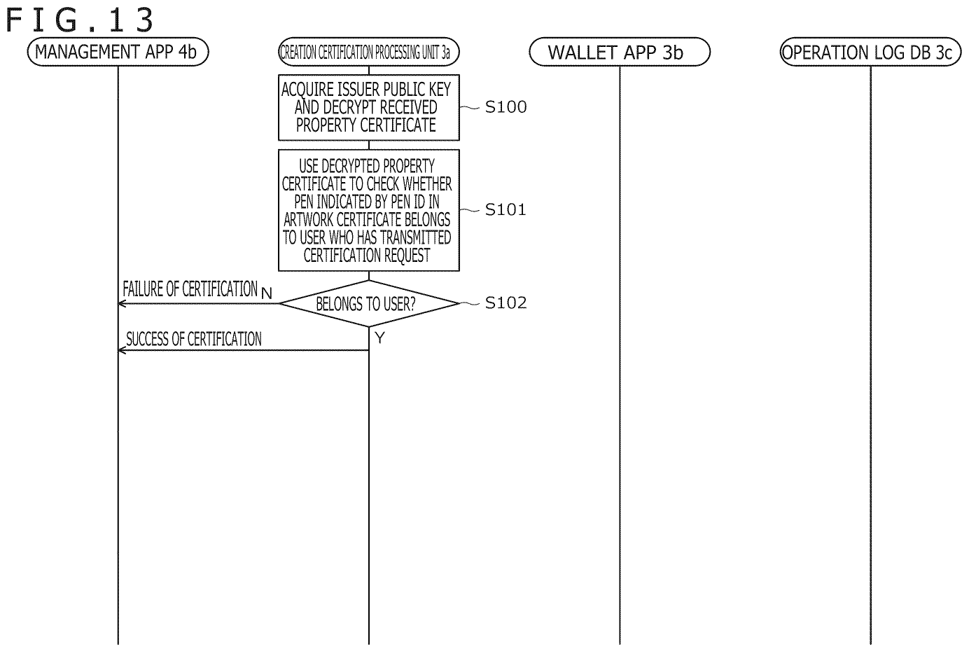

FIG. 13 is a process flow chart illustrating the process regarding the certification of the authorship performed by using the property certificate and the artwork certificate.

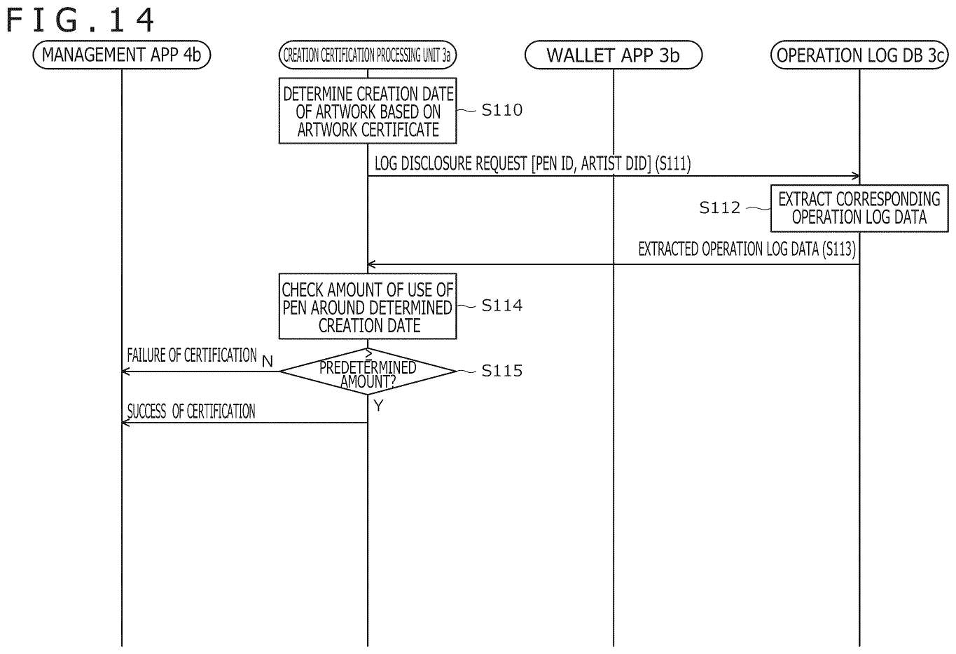

FIG. 14 is a process flow chart illustrating the process regarding the certification of the authorship performed by using the property certificate and the artwork certificate.

### DETAILED DESCRIPTION

Hereinafter, an embodiment of the present disclosure will be described in detail with reference to the attached drawings.

FIG. 1 is a diagram illustrating a configuration of an authorship certification system 1 according to the present embodiment. As illustrated in FIG. 1, the authorship certification system 1 includes a creation certification system 3 and a user terminal 4 connected to each other through a network 2.

FIG. 2 is a diagram illustrating an example of a hardware configuration of the creation certification system 3 and the user terminal 4. Each of the creation certification system 3 and the user terminal 4 may include a computer 100 having the illustrated configuration. Note that the creation certification system 3 may be provided by coupling a plurality of computers 100.

As illustrated in FIG. 2, the computer 100 includes a CPU (central processing unit) 101, a storage apparatus 102, an input apparatus 103, an output apparatus 104, and a communication apparatus 105 connected to each other through a bus 106.

The CPU 101 is an apparatus (processor) configured to control the components of the computer 100 and read and execute various programs stored in the storage apparatus 102. The CPUs 101 of the creation certification system 3 and the user terminal 4 execute programs stored in the storage apparatus 102 to execute the processes described with reference to FIGS. 3 to 14 described later.

The storage apparatus 102 includes a main storage apparatus, such as a DRAM (dynamic random access memory), and an auxiliary storage apparatus, such as a hard disk. The storage apparatus 102 plays a role of storing various programs for executing an operating system of the computer 100 and various applications and a role of storing data used by the programs. An operation log database 3c described later is implemented in the storage apparatus 102 of the creation certification system 3.

The input apparatus 103 is an apparatus that receives an input operation of a user and supplies the input operation to the CPU 101. The input apparatus 103 includes, for example, a keyboard, a mouse, and a touch detection apparatus. Of these, the touch detection apparatus is an apparatus including a touch sensor and a touch controller, and the touch detection apparatus is used for detecting pen input or touch input. A pen P illustrated in FIG. 1 is an electronic pen or an electromagnetic resonance pen used for performing pen input to the touch detection apparatus of the user terminal 4. The pen P includes a memory, and a pen ID (identification) that is identification information for uniquely identifying the pen P is stored in advance in the memory.

The pen input by the pen P is realized by a communication system corresponding to signal transmission at least from the pen P to the touch detection apparatus. Specific examples of the communication system include an active capacitive system and an electromagnetic resonance system. The signal transmitted by the pen P to the touch detection apparatus includes a data signal modulated by the pen ID. The touch detection apparatus can receive and demodulate the data signal to acquire the pen ID of the pen P.

The output apparatus 104 is an apparatus that outputs a processing result of the CPU 101 to the user, and the output apparatus 104 includes, for example, a display and a speaker. The communication apparatus 105 is an apparatus for communicating with external apparatuses, and the communication apparatus 105 transmits and receives data according to an instruction of the CPU 101. Each of the creation certification system 3 and the user terminal 4 uses the communication apparatus 105 to communicate with other apparatuses, systems, networks, and the like.

FIG. 1 will be further described. The user terminal 4 is a computer in which an artist as a creator of an artwork is the user. The user terminal 4 can execute a drawing app 4a for the artist to create the artwork and a management app 4b that executes a process related to certification of authorship of the artwork. Although only one user terminal 4 is illustrated in FIG. 1, a large number of user terminals may be actually connected to the network 2. Any computer, such as a personal computer, a tablet terminal, and a smartphone may be used as specific hardware of the user terminal 4.

The drawing app 4a is a drawing application corresponding to pen input and layers. The artist uses the pen P to input the artwork in each layer and lastly executes a rasterizing process to synthesize the layers to thereby complete one artwork. Hereinafter, data including a set of layers before synthesis will be referred to as “pre-synthesized data,” and image data obtained by rasterization will be referred to as “raster data.” The specific format of the pre-synthesized data and the raster data is not particularly limited. BMP, JPEG, PNG, TIFF, or the like may be suitably used as a format of the raster data. Hereinafter, the description will be continued by illustrating an example of using a PNG file as the raster data.

The management app 4b is an application that operates in the user terminal 4 as an agent of a creation certification processing unit 3a (described later) in the creation illumination system 3 and that functions as one virtual computer along with the creation certification processing unit 3a. The management app 4b specifically plays a role of also cooperating with the drawing app 4a to execute various processes related to the certification of the authorship of the artwork. The various processes include a process related to issuance of a property certificate for certifying that the artist possesses a property used to create the artwork, a process related to issuance of an artwork certificate for certifying that the creator of the artwork is the artist, and a process related to certification of the authorship using the property certificate and the artwork certificate.

Property identification information representing the property to be certified is written in the property certificate, which will be described in detail later. A typical example of the property is the pen P, and the property identification information in this case is the pen ID. However, a thing other than the pen P may be adopted as the property to be certified by the property certificate, as long as the thing is used to create the artwork and the thing is hardware or software that can identify each property. For example, the drawing app 4a may be used as the property, and the property identification information in this case is a serial number of the drawing app 4a. Hereinafter, the description will be continued based on the assumption that the property to be certified by the property certificate is the pen P.

The creation certification system 3 is a computer configured to issue a property certificate and an artwork certificate and use them to certify the authorship in response to a request from the management app 4b operating in the user terminal 4. As illustrated in FIG. 1, the creation certification system 3 includes the creation certification processing unit 3a, a wallet app 3b, and the operation log database 3c. The artist performs user registration in advance in the creation certification system 3 and uses the creation certification system 3 through the management app 4b.

The creation certification processing unit 3a is a functional unit that cooperates with the management app 4b to issue various DIDs including an artist DID and a project DID described later, issue a property certificate and an artwork certificate, and use the property certificate and the artwork certificate to certify the authorship. The DID is a decentralized ID used in self-sovereign identity (mechanism in which the user can possess and control the identity (hereinafter referred to as “ID”) of the user without the involvement of a management entity to thereby solve the problems of centralized ID management, Self-Sovereign Identity, hereinafter referred to as “SSI”), and the DID is permanently recorded in a blockchain network. In relation to the issuance of DID, the creation certification processing unit 3a generates a DID and a DID document that is a document provided with matters related to the DID. The creation certification processing unit 3a records the DID in a predetermined blockchain and stores the DID document in a distributed file system, such as an IPFS (InterPlanetary File System), to thereby issue a new DID. The DID includes a hash value (=address in the distributed file system) of the DID document. When issuing the DID, the creation certification processing unit 3a also executes a process of generating encryption keys corresponding to the DID (specifically, a pair of public key and private key based on public key cryptography).

The property certificate and the artwork certificate issued by the creation certification processing unit 3a may be verifiable certificates (hereinafter referred to as “VC”) used in the SSI. The property certificate and the artwork certificate that are VCs include an electronic signature obtained by using a private key of an issuer to encrypt a hash value of information to be certified. The person receiving the VCs along with the information to be certified can derive the hash value of the received information, use a public key of the issuer to decrypt the electronic signature, and compare the derived hash value and the decrypted electronic signature to thereby check the authenticity of the received information.

The wallet app 3b is an application prepared for each registered user of the creation certification system 3. When the user signs in to the creation certification system 3, the user can access the wallet app 3b of the user through the management app 4b. The wallet app 3b plays a role of storing the DID and the private key issued according to the request of the corresponding user and managing various certificates issued to the corresponding user. The property certificate and the artwork certificate may be physically stored in the wallet app 3b or in the distributed file system.

The operation log database 3c is a storage unit for storing operation log data of the pen P. The operation log data of the pen P may include the pen ID of the pen P, history data of the position of the pen P detected by the touch detection apparatus, and a time stamp indicating the time that the history data is recorded. Note that as described later with reference to FIG. 14 described later, the operation log data of the pen P is used to check whether the pen P is used in a certain period. Therefore, it is only necessary that the use can be checked based on the history data of the position of the pen P, and the history data does not have to include all positions detected by the touch detection apparatus. For example, the history data of the positions of the pen P may be history data of the position of the pen P acquired at intervals significantly longer than the intervals of the acquisition of the position acquired by the touch detection apparatus.

FIG. 3 is a diagram illustrating DID documents corresponding to three types of DIDs, that is, an artist DID, a project DID, and an issuer DID, used in the process of the creation certification processing unit 3a. The artist DID is a DID for identifying the artist, and the creation certification processing unit 3a issues the artist DID to the artist. The project DID is a DID for identifying a project as a container of the artwork, and the creation certification processing unit 3a issues the project DID to the artwork to be created by the artist. The issuer DID is a DID for identifying the issuer of the property certificate and the artwork certificate, that is, the creation certification system 3, and the creation certification system 3 issues the issuer DID in advance.

The content of each DID document will be described. First, the DID document of the artist DID includes an artist public key that is a public key corresponding to the artist DID as illustrated in FIG. 3A. In addition, the DID document of the issuer DID includes an issuer public key that is a public key corresponding to the issuer DID as illustrated in FIG. 3C.

The DID document of the project DID includes a project generation date, an artist DID, a pen ID, and a project public key as illustrated in FIG. 3B. Of these, the artist DID is a DID issued to the artist who creates the corresponding artwork, and the pen ID is a pen ID of the pen P used to create the corresponding artwork. Note that, for an artwork created together by a plurality of persons, a plurality of artist DIDs may be arranged in the DID document of the project DID. In addition, when, for example, a plurality of pens P are used to create one artwork, a plurality of pen IDs may be arranged in the DID document of the project DID. The project public key is a public key corresponding to the project DID.

Hereinafter, the issuance of the property certificate and the artwork certificate and the certification of the authorship based on the property certificate and the artwork certificate will be described in detail with reference to a flow chart of a process executed by the authorship certification system 1. Note that, when the wallet app 3b is simply referred to as “wallet app 3b” in the following description, it represents the wallet app 3b prepared for the artist who is the user of the user terminal 4.

FIG. 4 is a process flow chart illustrating a process regarding the issuance of the property certificate. As illustrated in FIG. 4, when the artist launches the drawing app 4a in the user terminal 4 (step 1), the management app 4b reads the pen ID (step S2). The reading will be specifically described. The management app 4b first displays a drawing area on a display through the drawing app 4a. When the user uses the pen P to enter any figure in the displayed drawing area, the pen P transmits the pen ID to the touch detection apparatus. The management app 4b receives the pen ID received in this way from the touch detection apparatus to thereby read the pen ID. Note that the management app 4b in step S2 may read the pen ID from each of a plurality of pens P.

Next, the management app 4b accesses and signs in to the creation certification processing unit 3a of the creation certification system 3 (step S3). As described above, the artist performs the user registration in advance in the creation certification system 3, and the management app 4b uses user information (such as sign-in ID and password) regarding the user registration to sign in to the creation certification system 3.

Next, the management app 4b transmits a property certification issue request including one or more pen IDs read in step S2 to the creation certification processing unit 3a (step S4). The creation certification processing unit 3a that has received the request first issues an artist DID (step S5). Specifically, the creation certification processing unit 3a generates a key pair including an artist public key and an artist private key that is a private key corresponding to the artist public key and then generates an artist DID and a DID document of the artist DID (see FIG. 3A). Next, the creation certification processing unit 3a generates an artist DID and a DID document of the artist DID (see FIG. 3A). The creation certification processing unit 3a then causes the distributed file system to store the generated DID document and records the artist DID in the blockchain. In addition, the creation certification processing unit 3a transmits the generated artist DID and artist private key to the wallet app 3b (step S6) and causes the wallet app 3b to store them (step S7).

After the completion of the process so far, the creation certification processing unit 3a issues a property certificate to the artist DID (step S8).

FIG. 5 is a diagram illustrating content of the property certificate issued in step S8. As illustrated in FIG. 5, the property certificate includes issuer information representing the issuer of the property certificate (that is, the creation certification system 3) and pen ID certification information necessary for certifying the pen ID. Of these, the issuer information includes an issuer name and an issuer DID. On the other hand, the pen ID certification information includes the artist DID issued in step S5 and one or more pen IDs included in the property certificate issue request. FIG. 5 illustrates an example of a property certificate provided with two pen IDs in the pen ID certification information. The pen ID certification information is encrypted by the issuer private key and arranged in the property certificate.

FIG. 4 will be further described. The creation certification processing unit 3a transmits the issued property certificate to the wallet app 3b along with the artist DID (step S9) and causes the wallet app 3b to store the property certificate in association with the artist DID (step S10). In this way, the artist as the user of the user terminal 4 can use the property certificate through the management app 4b and the creation certification system 3.

FIGS. 6 to 8 and 10 are a process flow chart illustrating a process regarding the issuance of the artwork certificate. First, FIG. 6 will be described. The management app 4b first executes a process similar to steps S1 to S3 illustrated in FIG. 4 (steps S20 to S22).

The management app 4b that has signed in to the creation certification processing unit 3a accesses the wallet app 3b and acquires the artist DID (step S23). The management app 4b then transmits a pen check request including the acquired artist DID and the pen ID read in step S21 to the creation certification processing unit 3a (step S24).

The creation certification processing unit 3a that has received the pen check request transmits a presentation request of the property certificate including the artist DID to the wallet app 3b (step S25). The wallet app 3b that has received the request acquires the property certificate corresponding to the artist DID and transmits the property certificate to the creation certification processing unit 3a (step S26). The creation certification processing unit 3a then specifies the pen P indicated by the pen ID in the pen check request as a pen used to create the artwork (step S27), checks whether or not the pen ID of the specified pen P is written in the property certificate received in step S26 (step S28), and transmits a check result to the management app 4b (step S29).

The management app 4b that has received the check result determines whether or not the pen ID read in step S21 is written in the property certificate based on the received check result (step S30). As a result of the determination, if the management app 4b determines that the pen ID is written, the management app 4b launches a creation proof recording function for recording information that is a proof of creation during the creation of the artwork (step S31) and advances to step S40 of FIG. 7. On the other hand, if the management app 4b determines that the pen ID is not written, the management app 4b ends the process without launching the creation proof recording function. In this case, the artwork certificate is not issued even if the artist has created the artwork.

FIG. 7 will be further described. When the artist performs an operation for starting the creation after the creation proof recording function is launched in step S30 (step S40), the management app 4b transmits a creation start request to the creation certification processing unit 3a (step S41). The creation certification processing unit 3a that has received the request issues a project DID to the artwork to be created by the artist (step S42). Specifically, the creation certification processing unit 3a generates a key pair including a project public key and a project private key that is a private key corresponding to the project public key and then generates a project DID and a DID document of the project DID (see FIG. 3B). In this case, the artist DID and the pen ID arranged in the generated DID document are the artist DID and the pen ID included in the pen check request received in step S24 of FIG. 6. The creation certification processing unit 3a causes the distributed file system to store the generated DID document and records the project DID in the blockchain. In addition, the creation certification processing unit 3a transmits the generated project DID and project private key to the wallet app 3b (step S43) and causes the wallet app 3b to store them (step S44).

After the storage of the project DID by the wallet app 3b is completed, the management app 4b acquires the project DID from the wallet app 3b (step S45). The management app 4b subsequently acquires the operation log data as necessary (step S46) while the artist uses the drawing app 4a to create the artwork, and the management app 4b records the acquired operation log data in association with the project DID and the artist DID (step S47). The management app 4b then transmits the operation log data recorded so far and information including the artist DID and the name of the drawing app 4a to the operation log database 3c at any timing during the creation or after the completion of the creation (S48). The operation log database 3c that has received the information stores the received operation log data in association with the received artist DID and name of the management app 4b (step S49). Note that the project DID may also be transmitted from the management app 4b to the operation log database 3c, and the operation log database 3c may store the operation log data in association with also the project DID.

FIG. 8 will be described. When the artist performs a predetermined operation indicating the completion of the creation (step S50), the management app 4b acquires the PNG file and various properties (such as the generation date of the PNG file and the name of the drawing app 4a) of the work from the drawing app 4a (step S51) and transmits an artwork certificate issue request including the generated information to the creation certification processing unit 3a (step S52). The creation certification processing unit 3a that has received the request first searches for an image identical or similar to the received PNG file online (step S53) and determines whether or not there is an identical or similar image (step S54). As a result of the determination, if the creation certification processing unit 3a determines that there is an identical or similar image, the creation certification processing unit 3a returns, to the management app 4b, an issue unavailable notification indicating that the artwork certificate cannot be issued. In this case, the artwork certificate is not issued.

Note that, when the creation certification processing unit 3a determines that there is an identical or similar image in step S54, the creation certification processing unit 3a may ask the artist to insert a written oath for swearing that the artwork indicated by the received PNG file is not created based on an image existing online. In this case, it is preferable that the creation certification processing unit 3a advance the process to step S54 only when the written oath is inserted and include the written oath in the artwork certificate issued in step S55 described later.

If the creation certification processing unit 3a determines that there is no identical or similar image in step S54, the creation certification processing unit 3a issues an artwork certificate to the project DID (step S55).

FIG. 9 is a diagram illustrating content of the artwork certificate issued in step S55. Here, the artwork certificate of FIG. 9 also includes content additionally written in steps S62 and S69 described later. As illustrated in FIG. 9, the artwork certificate includes issuer information representing the issuer of the artwork certificate (that is, the creation certification system 3) and authorship certification information necessary for certifying the authorship of the artwork. Of these, the issuer information includes the issuer name and the issuer DID, as with the issuer information in the property certificate illustrated in FIG. 5. On the other hand, the authorship certification information includes the project DID issued in step S42 of FIG. 7, the artist DID and the pen ID transmitted from the management app 4b to the creation certification processing unit 3a in step S24 of FIG. 6, the hash value and the generation date of the PNG file acquired in step S51 of FIG. 8, a hash value of the processed PNG file described later, the date of registration of the artwork certificate to the distributed file system, a generation date and a file format of the pre-synthesized data described later, the information representing the result of the online image check executed in steps S53 and S54 of FIG. 8, and the like. The authorship certification information is encrypted by the issuer private key and arranged in the artwork certificate.

FIG. 8 will be further described. The creation certification processing unit 3a transmits the issued artwork certificate to the wallet app 3b along with the project DID and the artist DID (step S56) and causes the wallet app 3b to store the artwork certificate in association with the project DID and the artist DID (step S57). In this way, the artist as the user of the user terminal 4 can use the artwork certificate through the management app 4b and the creation certification system 3.

FIG. 10 will be described. The creation certification processing unit 3a then executes a process of converting the project DID into a watermark and embedding the watermark into the PNG file (step S60). The specific mode of the watermark and the method of embedding the watermark into the raster data are not particularly limited. For example, as illustrated in Japanese Patent Laid-Open No. 2022-002130, a method of using a two-dimensional code representing the project DID as a watermark and using singular value decomposition to embed the watermark into one of three color channels included in the PNG file can be used.

In addition, the creation certification processing unit 3a executes a process of arranging the pen ID in metadata (for example, chunk) of the PNG file (step S61). Hereinafter, the PNG file obtained through the process of steps S60 and S61 will be referred to as a “processed PNG file.”

Next, the creation certification processing unit 3a derives the hash value of the processed PNG file (step S62) and additionally writes the derived hash value to the artwork certificate (step S63). The creation certification processing unit 3a then transmits the artwork certificate after the additional writing to the wallet app 3b (step S64). The wallet app 3b that has received the artwork certificate updates the stored artwork certificate with the received artwork certificate (step S65).

In addition, the creation certification processing unit 3a also executes a process of transmitting the processed PNG file to the management app 4b (step S66). The management app 4b stores the received processed PNG file in the storage apparatus 102 (see FIG. 2) of the user terminal 4 (step S67). The processed PNG file stored in the user terminal 4 in this way is used later by the artist to request for the certification of the authorship and may also be used to upload the processed PNG file to an online service, such as a social networking service and an online market service.

Subsequently, the management app 4b and the creation certification processing unit 3a may execute a process of steps S68 to S72. Specifically, the management app 4b first acquires the pre-synthesized data of the work (step S68) and transmits the pre-synthesized data to the creation certification processing unit 3a (step S69). The creation certification processing unit 3a additionally writes information representing the received pre-synthesized data to the artwork certification (step S70). The generation date and the file format of the pre-synthesized data illustrated in FIG. 9 is an example of the information additionally written to the artwork certificate in this way. Note that the creation certification processing unit 3a may additionally write information different from them to the artwork certificate. For example, a hash value of the pre-synthesized data may be additionally written, and in this way, whether the pre-synthesized data is possessed can be used as a piece of evidence for certifying the authorship of the artwork. The creation certification processing unit 3a finished with step S70 transmits the artwork certificate after the additional writing to the wallet app 3b (step S71). The wallet app 3b that has received the artwork certificate updates the stored artwork certificate with the received artwork certificate (step S72).

As described so far, the authorship certification system 1 of the present embodiment can issue the property certificate and the artwork certificate used for certifying the authorship of the artwork.

FIGS. 11 to 14 are a process flow chart illustrating a process regarding the certification of the authorship performed by using the property certificate and the artwork certificate issued as described above. The process is started when a certification request is transmitted from the management app 4b to the creation certification processing unit 3a (step S80). The certification request includes the processed PNG file provided with the watermark representing the project DID (processed PNG file stored in the user terminal 4 in step S67 of FIG. 10), and the certification request plays a role of inputting the project DID to the creation certification processing unit 3a.

The creation certification processing unit 3a that has received the certification request reads the watermark embedded into the received processed PNG file to thereby specify the input project DID (step S81). The creation certification processing unit 3a then specifies the artist DID based on the specified project DID (step S82). Specifically, the creation certification processing unit 3a can access the distributed file system based on the specified project DID and refer to the DID document of the project DID to specify the artist DID.

The creation certification processing unit 3a then transmits an artwork certificate presentation request including the specified project DID and artist DID to the wallet app 3b (step S83). The wallet app 3b that has received the request selects a corresponding artwork certificate from one or more managing artwork certificates and signs the artwork certificate with a corresponding artist private key (step S84). Specifically, the wallet app 3b can derive a hash value of the selected artwork certificate to encrypt the hash value with the artist private key and attach the encrypted hash value as an electronic signature to the artwork certificate. Subsequently, the wallet app 3b returns the generated artwork certificate with electronic signature to the creation certification processing unit 3a (step S85).

The creation certification processing unit 3a that has received the artwork certificate with electronic signature acquires the artist public key and verifies the received electronic signature (step S86). Specifically, the creation certification processing unit 3a accesses the distributed file system based on the artist DID specified in step S82 and refers to the DID document of the artist DID to thereby acquire the artist public key. The creation certification processing unit 3a can then use the acquired artist public key to decrypt the received electronic signature, derive the hash value of the received artwork certificate, and compare them to verify the electronic signature. The creation certification processing unit 3a that has verified the electronic signature determines whether or not the verification has succeeded (step S87). As a result of the determination, if the creation certification processing unit 3a determines that the verification has failed, the creation certification processing unit 3a returns a failure of certification to the management app 4b and ends the process. On the other hand, the creation certification processing unit 3a that has determined that the verification has succeeded moves the process to step S90 of FIG. 12.

FIG. 12 will be described. The creation certification processing unit 3a in step S90 acquires the issuer public key and decrypts the received artwork certificate (authorship certification information in the artwork certificate). The creation certification processing unit 3a then compares the project DID and the artist DID in the decrypted artwork certificate with the project DID and the artist DID specified in steps S81 and S82 (step S91). The creation certification processing unit 3a then determines whether or not they coincide with each other (step S92). If the creation certification processing unit 3a determines that they do not coincide with each other, the creation certification processing unit 3a returns a failure of certification to the management app 4b and ends the process. On the other hand, the creation certification processing unit 3a that has determined that they coincide with each other transmits a property certificate presentation request including the artist DID to the wallet app 3b (step S93).

The wallet app 3b that has received the property certificate presentation request selects a corresponding property certificate from one or more managing property certificates and signs the property certificate with a corresponding artist private key (step S94). Specifically, as in step S84 illustrated in FIG. 11, the wallet app 3b can derive a hash value of the selected property certificate to encrypt the hash value with the artist private key and attach the encrypted hash value as an electronic signature to the property certificate. Subsequently, the wallet app 3b returns the generated property certificate with electronic signature to the creation certification processing unit 3a (step S95).

The creation certification processing unit 3a that has received the property certificate with electronic signature acquires the artist public key and verifies the received electronic signature (step S96). Specifically, as in step S86 illustrated in FIG. 11, the creation certification processing unit 3a can access the distributed file system based on the artist DID specified in step S82 and refer to the DID document of the artist DID to acquire the artist public key. The creation certification processing unit 3a can then use the acquired artist public key to decrypt the received electronic signature, derive the hash value of the received property certificate, and compare them to verify the electronic signature. The creation certification processing unit 3a that has verified the electronic signature determines whether or not the verification has succeeded (step S97). As a result of the verification, if the creation certification processing unit 3a determines that the verification has failed, the creation certification processing unit 3a returns a failure of certification to the management app 4b and ends the process. On the other hand, the creation certification processing unit 3a that has determined that the verification has succeeded moves the process to step S100 of FIG. 13.

FIG. 13 will be described. The creation certification processing unit 3a in step S100 acquires the issuer public key and decrypts the received property certificate (pen certification information in the property certificate). The creation certification processing unit 3a then uses the decrypted property certificate to check whether the pen P indicated by the pen ID in the artwork certificate decrypted in step S90 belongs to the artist indicated by the specified artist DID (step S101) and determines the result of the check (step S102). Specifically, the creation certification processing unit 3a can determine whether or not the pen ID in the artwork certificate is written in the property certificate. The creation certification processing unit 3a can determine that the pen ID belongs to the artist if the pen ID is written and determine that the pen ID does not belong to the artist if the pen ID is not written. As a result of the determination of step S102, if the creation certification processing unit 3a determines that the pen ID belongs to the artist, the creation certification processing unit 3a returns a success of certification to the management app 4b and ends the process. On the other hand, if the creation certification processing unit 3a determines that the pen ID does not belong to the artist, the creation certification processing unit 3a returns a failure of certification to the management app 4b and ends the process.

Here, the creation certification processing unit 3a that has determined that the pen ID is included in step S102 may further execute a process from step S110 illustrated in FIG. 14 before returning the success of certification. Specifically, the creation certification processing unit 3a first determines the creation date of the artwork based on the writing in the artwork certificate (step S110). For example, the creation certification processing unit 3a can determine that the generation date of the PNG file or the generation date of the pre-synthesized data included in the artwork certificate is the creation date of the artwork.

The creation certification processing unit 3a then transmits a log disclosure request including the pen ID and the artist DID written in the artwork certificate to the operation log database 3c (step S111). The operation log database 3c that has received the request extracts corresponding operation log data (step S112) and returns the operation log data to the creation certification processing unit 3a (step S113).

Here, the creation certification processing unit 3a may arrange the creation date determined in step S110 in the log disclosure request. It is preferable that the operation log database 3c in this case extract operation log data recorded around the creation date included in the log disclosure request. Here, “around the creation date” can be, for example, within a predetermined time before the creation date. In addition, the creation certification processing unit 3a may arrange the project DID in the log disclosure request, in place of the artist DID or in addition to the artist DID. It is preferable that the operation log database 3c in this case extract operation log data corresponding to the project DID included in the log disclosure request.

Next, the creation certification processing unit 3a checks an amount of use of the pen P around the creation date determined in step S110 based on the received operation log data (step S114). Specific meaning of “around the creation date” may be similar to the meaning described above. The creation certification processing unit 3a then determines whether or not the checked amount of use of the pen P is equal to or greater than a predetermined amount (step S115). If the creation certification processing unit 3a determines that the amount of use is equal to or greater than the predetermined amount, the creation certification processing unit 3a returns a success of certification to the management app 4b and ends the process. On the other hand, the creation certification processing unit 3a that has determined that the amount of use is not equal to or greater than the predetermined amount returns a failure of certification to the management app 4b and ends the process. According to the process from step S110 described above, the creation certification processing unit 3a can check whether the pen P indicated by the pen ID written in the artwork certificate is really used around the creation date of the processed PNG file received in step S80 of FIG. 11 and then certify the authorship.

As described above, the authorship certification system 1 of the present embodiment can certify the authorship of the artwork with a simple method of using the property, such as the pen P, used by the artist in creating the artwork.

In addition, the property certificate is issued separately from the artwork certificate, and the property certificate certifies that the property belongs to the artist. Therefore, the authorship of the artwork can be certified even if the property does not exist at the time of the certification.

In addition, the artwork certificate and the property certificate are stored in the wallet app 3b for the artist, and the project DID necessary for specifying the artwork certificate is watermarked and embedded into the artwork. Therefore, the artist can just present the artwork provided with the watermark to prove the authorship.

Although the preferred embodiment of the present disclosure has been described, the present disclosure is not limited to the embodiment in any way, and it is obvious that the present disclosure can be carried out in various modes without departing from the scope of the present disclosure.

For example, in the example described in the embodiment, the property certificate certifies that the property belongs to the artist. However, whether the user possesses the pen P indicated by the pen ID written in the artwork certificate may be checked again in the stage of the authorship certification to thereby certify the relationship between the artist and the property. Specifically, the management app 4b may execute a process similar to step S2 of FIG. 4 or step S21 of FIG. 6 to read one or more pen IDs before executing step S80 of FIG. 11 and arrange the read one or more pen IDs in the certification request. Instead of the process of steps S93 to S102, the creation certification processing unit 3a may check whether or not the pen ID received along with the certification request coincides with the pen ID in the artwork certificate to thereby check whether or not the property belongs to the artist. Note that, when a plurality of pen IDs are written in the artwork certificate, the creation certification processing unit 3a may determine that the property belongs to the artist if one of one or more pen IDs received along with the certification request coincides with one of the plurality of pen IDs written in the artwork certificate.

In addition, the creation certification processing unit 3a returns the success or failure of certification in response to the certification request from the artist to certify the authorship in the example described in the embodiment. However, it is obvious that the authorship can be certified in another format. For example, when the artist attempts to upload the processed PNG file to an online market service, such as a social networking service and an online market service, the authorship may be certified in the background, and the uploading may be permitted only if the certification has succeeded. According to this, the rights of the artist can be protected without the artist being conscious of the certification process of the authorship.

In addition, although the generation date of the PNG file and the generation date of the pre-synthesized data are arranged in the artwork certificate in the embodiment, the time of the artist starting the creation in step S40 of FIG. 7 and the time of the artist completing the creation in step S50 of FIG. 7 may be arranged in the artwork certificate, in addition to or in place of the generation dates. In this way, when the amount of use of the pen P is checked in step S114 of FIG. 14, the period from the start to the completion of the creation can be used as “around the creation date” for limiting the period to be checked.

Furthermore, the creation certification processing unit 3a may compare the pen ID written in the artwork certificate decrypted in step S90 and the pen ID arranged in the metadata of the processed PNG file input in step S80 of FIG. 11 (pen ID arranged in step S61 of FIG. 10) before executing step S93 of FIG. 12, for example. The creation certification processing unit 3a may return a failure of certification to the management app 4b if the pen IDs do not coincide. In this way, the authorship can be more accurately certified.

### DESCRIPTION OF REFERENCE SYMBOLS

1: Authorship certification system
2: Network
3: Creation certification system
3a: Creation certification processing unit
3b: Wallet app
3c: Operation log database
4: User terminal
4a: Drawing app
4b: Management app
100: Computer
101: CPU
102: Storage apparatus
103: Input apparatus
104: Output apparatus
105: Communication apparatus
106: Bus
P: Pen

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A determination method of using a computer to determine authorship of an artwork, the determination method comprising:
specifying, by the computer, hardware or software used by an artist in creating the artwork; and
generating, by the computer, a first certificate including identification information representing the hardware or software used by the artist in creating the artwork and a first decentralized identifier related to the artwork.

2. The determination method according to claim 1, further comprising:
receiving, by the computer, the first decentralized identifier;
acquiring, by the computer, the first certificate including the first decentralized identifier; and
determining, by the computer, the authorship of the artwork based on the hardware or the software indicated by the identification information included in the first certificate.

3. The determination method according to claim 1, further comprising:
generating, by the computer, a second decentralized identifier for identifying the artist; and
generating, by the computer, a second certificate including the second decentralized identifier and the identification information.

4. The determination method according to claim 3, wherein
the first certificate further includes the second decentralized identifier,
the determination method further includes:
acquiring, by the computer, the second certificate corresponding to the second decentralized identifier included in the first certificate, and
the computer determines whether or not the identification information included in the first certificate is included in the second certificate to determine the authorship of the artwork.

5. The determination method according to claim 2, wherein
the first certificate further includes creation date information representing a creation date of the artwork,
the determination method further includes:
recording, by the computer, log data of the hardware or the software in creating the artwork, and
the computer determines the authorship of the artwork based on the log data recorded at a date around the date indicated by the creation date information included in the first certificate.

6. The determination method according to claim 2, further comprising:
embedding, by the computer, a watermark representing the first decentralized identifier into the artwork; and
receiving, by the computer, the artwork provided with the watermark, wherein
the computer reads the watermark from the artwork to receive the first decentralized identifier and acquires the first certificate corresponding to the received first decentralized identifier.

7. The determination method according to claim 6, further comprising:
deriving, by the computer, a hash value of the artwork provided with the watermark,
wherein the first certificate further includes the hash value.

8. The determination method according to claim 1, wherein
the hardware or the software includes a pen used by the artist to create the artwork, and
the identification information includes a pen identification that uniquely identifies the pen.

9. The determination method according to claim 1, further comprising:
searching, by the computer, for an image identical or similar to the artwork online,
wherein the computer does not generate the first certificate when the image identical or similar to the artwork exists online.

10. The determination method according to claim 1, wherein
the identification information and the first decentralized identifier are encrypted by a private key of an issuer of the first certificate and included in the first certificate.

11. The determination method according to claim 3, wherein
the second decentralized identifier and the identification information are encrypted by a private key of an issuer of the second certificate and included in the second certificate.

12. A computer configured to:
specify hardware or software used by an artist in creating an artwork; and
generate a first certificate including identification information representing the specified hardware or software and a first decentralized identifier that is a decentralized identifier related to the artwork.

13. A program for causing a computer to execute a process of:
specifying hardware or software used by an artist in creating an artwork; and
generating a first certificate including identification information representing the specified hardware or software and a first decentralized identifier that is a decentralized identifier related to the artwork.
